(19) United States
(12) Patent Application Publication
(10) Pub. No.: US 2006/0047555 A1
(43) Pub. Date: Mar. 2, 2006

(54) Method and system for re-authorizing workflow objects

(75) Inventors: Chih-Chiang Kang, Keelung City (TW); Jenny Chang, Kaohsiung City (TW); Pei Chao, Hsinchu County (TW)

Correspondence Address: HAYNES AND BOONE, LLP, 901 MAIN STREET, SUITE 3100, DALLAS, TX, 75202, US

(73) Assignee: Taiwan Semiconductor Manufacturing Company, Ltd., Hsin-Chu (TW)

(21) Appl. No.: 10/928,382

(22) Filed: Aug. 27, 2004

(51) Int. Cl. G06F 15/02

(52) U.S. Cl. 705/9

(57) ABSTRACT

A method and system for re-authorizing workflow objects are disclosed. The system includes a system agent that determines if a received workflow object, such as a document which requires approvals, is impacted by changes in an organizational hierarchy. If a particular received workgroup object is so impacted, the system agent forwards the impacted workflow object to a re-authorization engine. The re-authorization engine then applies re-authorization rules to determine a new and correct routing path for the impacted workflow object.

### BACKGROUND

The present disclosure relates generally to workflow systems, and more particularly, to workflow systems that accommodate changes in an organizational hierarchy.

Workflow systems provide for the electronic routing of documents for review and approval. Workflow systems provide many advantages over prior paper-based review and approval systems. In particular, electronic workflow systems save vast amounts of paper and are much faster than earlier systems. The greater the number of approvals required to take a particular action, the greater the advantages a workflow system tends to provide.

In many workflow systems, the authority and routing path for approval is determined at the time when the workflow object is input into the workflow system for routing and approval. A workflow object can be a proposal that requires the approval of one or more individuals. For example, an engineer in department X of a work entity, for example a corporation, submits a workflow object for approval to a workflow system. At the time the workflow object is submitted to the system, the workflow object is assigned to be transmitted to the supervisor of department X for approval and then to the manager of group Y. The authority and routing path is thus fixed once submitted to the workflow system. A significant disadvantage of such a system is that once the workflow object or application is submitted to the workflow system, the next approver, or next stage, can not be changed. This results in delay, customer complaints, and the waste of human resources needed to manually handle or correct the routing of the workflow object when the workflow hierarchy has changed.

Accordingly, what is needed is a workflow system and method which solves the problems described above.

### BRIEF DESCRIPTION OF THE DRAWINGS

FIG. 1 is a block diagram of a conventional workflow system.

FIG. 2 is a block diagram of the disclosed workflow system.

FIG. 3A is a diagram illustrating process flow among several of the blocks of the disclosed workflow system.

FIG. 3B is a diagram illustrating process flow among the remaining blocks of the disclosed workflow system.

FIGS. 4A-4C are rule configuration examples for the system agent of the disclosed workflow system.

FIGS. 5A and 5B are rule configuration examples for the reauthorization engine of the disclosed workflow system.

### DETAILED DESCRIPTION

The present disclosure relates generally to a workflow system and method that dynamically accommodates changes in the workflow hierarchy. It is understood, however, that the following disclosure provides many different embodiments, or examples, for implementing different features of the disclosure. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

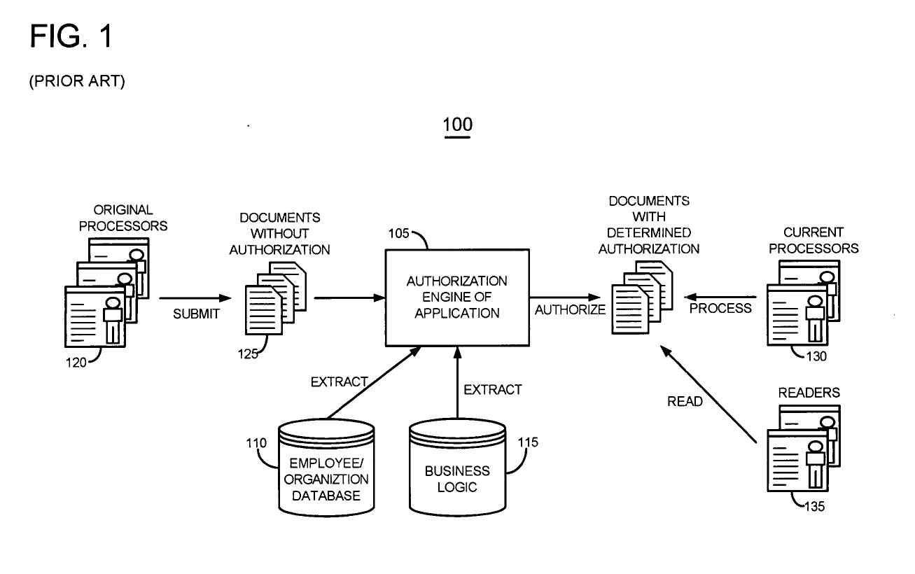

Referring to FIG. 1, a conventional workflow system is shown generally as system 100. System 100 includes an authorization engine 105 which is a program or application residing on an information handling system or computer (not shown). An employee/organization database 110 is coupled to authorization engine 105 to provide the authorization engine with information regarding the organizational hierarchy of the particular organization in which the system is to be employed. For example, organization database 110 includes employee name, department manager, group manager, etc. A business logic database 115 is also coupled to authorization engine 105 to provide rules to assist in determining the approval path for each workflow object submitted to the system by original processors 120. Original processors 120 are typically individuals initiating a particular request or workflow object 125 that requires approval by other individuals in the organizational hierarchy. At this point workflow object 125 may be an object without authorization for which approval is being sought. Upon submission of the workflow object 125 to a typical conventional authorization engine 105, the authorization engine determines and fixes the routing and approval path for the particular workflow object. Authorization engine 105 routes the workflow object to current processors 130, for example first to a first line manager, then to a second line manager and finally to a third line manager for approval. Each manager can take an amount of time to review and approve the workflow object before it is sent along to the next manager for approval. Courtesy copies of the workflow object can also be sent to readers 135 whose approval is not required. Since the routing path to the various managers, i.e. to current processors 130, is fixed by authorization engine 105 at the time the workflow object is submitted, problems can result if the hierarchy changes after submission of the workflow object and prior to approval. Current processors or managers that should no longer receive a particular workflow object may still receive the object. Managers or readers who have left the organization or changed positions within the organizational may still receive the workflow object even though they are no longer authorized to do so. If a current processor no longer exists, then it is possible that no one has processing authority for a particular workflow object. With the conventional workflow system described above, it is possible that many workflow objects or requests may be misdirected to wrong approval routes. This can lead to wasted time manually correcting the routing and approval path.

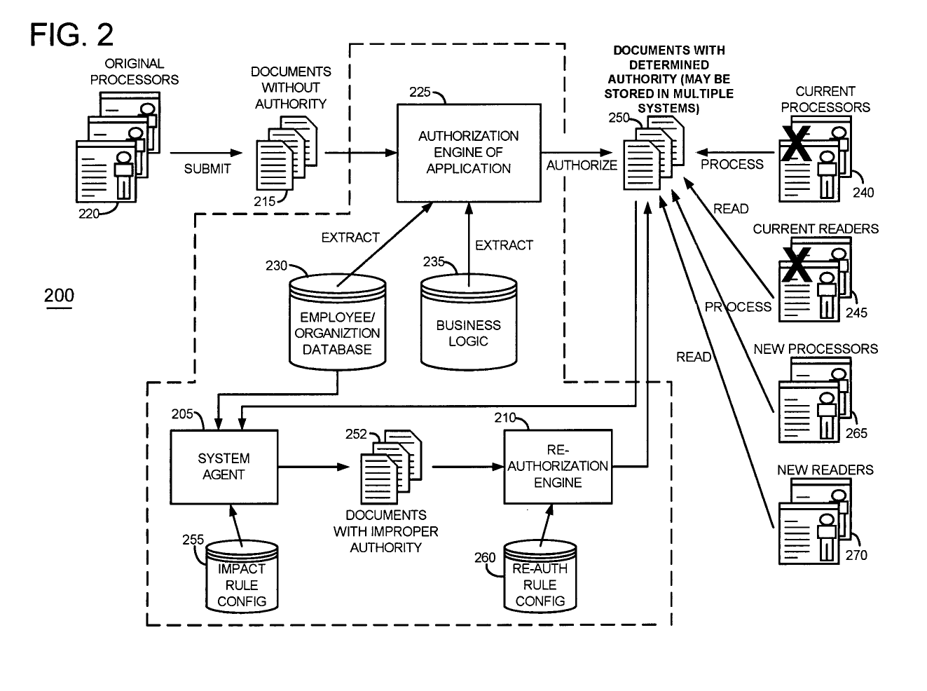

FIG. 2 shows one embodiment of the disclosed workflow system 200 that addresses the problems described above. System 200 includes a system agent 205 which seeks out workflow objects or documents that are impacted by a change in the organizational hierarchy. System agent 205 cooperates with a re-authorization engine 210 that takes the impacted workflow objects or documents and sends the impacted workflow objects to new processors who are found to be the appropriate processors after taking into account the change in the organizational hierarchy. This re-authorization is triggered by the change event in the organizational hierarchy which is monitored by system agent 205. Thus, the re-authorization may be referred to as being event triggered in this embodiment.

Workflow objects 215, or documents without authority, are prepared by original processors 220 who submit such documents to an input of authorization engine 225. Workflow objects may include documents, proposals and other items requiring approval by processors in an organizational hierarchy. For convenience, workflow objects are shown as documents within the drawings. Workflow objects input by original processors 220 are referred to as “documents without authority” because the processors for such workflow objects have not yet been determined by authorization engine 225 and such workflow objects are not yet approved. By extracting information from employee/organization database 230 and applying business logic from business logic database 235, authorization engine 225 determines the appropriate individuals within the organizational hierarchy who should receive the workflow object for approval. For example, authorization engine 225 will route a particular workflow object to current processors 240 for approval and to current readers 245 on a “for your information” or FYI basis. Once authorization engine 225 determines the processors for a particular workflow object, the object is referred to as a “document with determined authority” 250 and current processors 240 and current readers 245 are associated with the workflow object. However, it is possible that one or more of the current processors or current readers may not be correct if there has been an organizational change. It is noted that documents with determined authority may reside on multiple information handling systems (not shown) which are located within the organizational hierarchy.

System agent 205 monitors documents with determined authority 250 to determine which of these documents or workflow objects have improper authority, i.e. have incorrect current processors or current readers associated therewith. In other words, system agent 205 determines those documents 250 which are impacted by a change in the organizational hierarchy. Documents 250 which are impacted by an organizational change are referred to as “documents with improper authority” 252. System agent 205 can be an application program residing on an information handling system (not shown) or may be implemented as dedicated hardware if desired. Events which can trigger system agent 205 to flag a particular impacted document include an employee leaving the organization, an employee changing positions within the organization, a processor leaving the organization, a processor changing positions within the organization, a reader leaving the organization and a reader changing positions within the organization, for example. To enable system agent 205 to select impacted documents stored in multiple systems, system agent 205 receives impact rules from an impact rule configuration storage 255. In one embodiment, each information handling system on which documents are stored has its own set of rules for determining impacted documents. In actual practice, all of these rules are stored in rule configuration storage 255 which can be located in a dedicated information handling system or other storage location. Once triggered, the system agent detects all impacted documents based on the rule configuration. The impacted documents may be stored in stored in the same information handling system as rule configuration storage 255 or a separate information handling system dedicated to impacted documents, or a shared information handling system.

Re-authorization engine 210 receives pending documents with improper authority 252 and reauthorizes these documents to new processors 265 and new readers 270 according to re-authorization rules provided thereto by re-authorization rule configuration storage 260. In FIG. 2, current processors 240 and current readers 245 as designated with an “X” to indicate that these processors and readers are no longer the proper processors and readers for a particular impacted document or workflow object. In actual practice rule configuration storages 255 and 260 may be combined. Moreover, system agent 205 and re-authorization engine 210 may be implemented in software on respective coupled information handling systems or on a single information handling system. Once re-authorization engine 260 determines the appropriate new processors 265 and new readers 270 for a particular impacted document, that document is transmitted to the new processors for approval and to the new readers for reading.

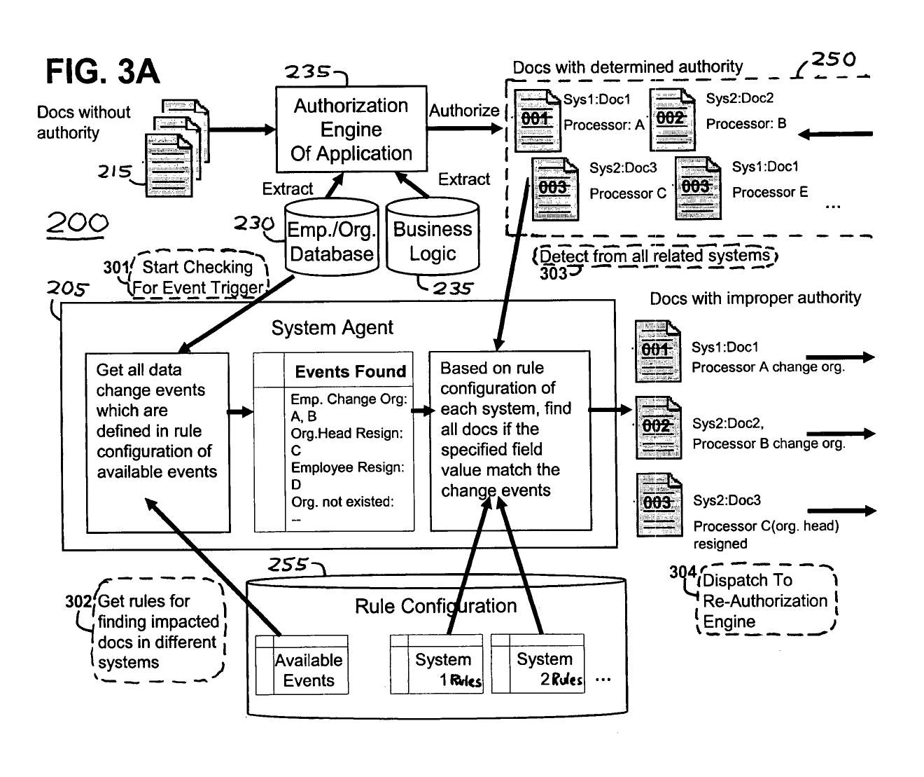

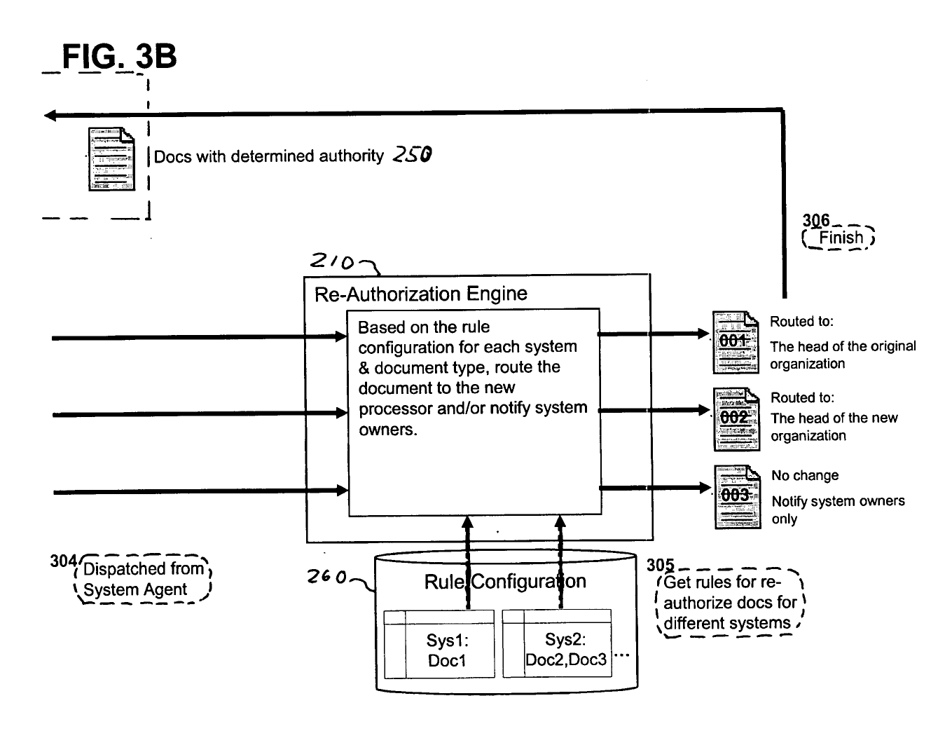

FIGS. 3A and 3B together form a more detailed representation of workflow system 200 shown previously in FIG. 2. In the discussion of FIGS. 3A and 3B particular emphasis will be given to system agent 205 and re-authorization engine 210. When workflow objects without authority 215 are submitted to authorization engine 235, authorization engine 235 consults employee/organization database 230 and business logic 235 to make an initial determination of the processors and readers to whom the workflow object or document should be sent for approval or reading. In another embodiment, the submitter can provide an initial approval path for a workflow object or document and then the system can check the validity of that path. The workflow objects or documents 250 to be reviewed and read may be stored on multiple information handling system as indicated in FIG. 3A which shows documents 250 as including document 001 (Sys1:Doc1, Processor A), document 002 (Sys2:Doc2 Processor B,), document 003 (Sys2:Doc3, Processor C) and document 004 (Sys1:Doc1, Processor E). Sys1 and Sys2 refer to different information handling systems on which the documents may be stored. Processors A, B, C and D refer to different human processors for the documents.

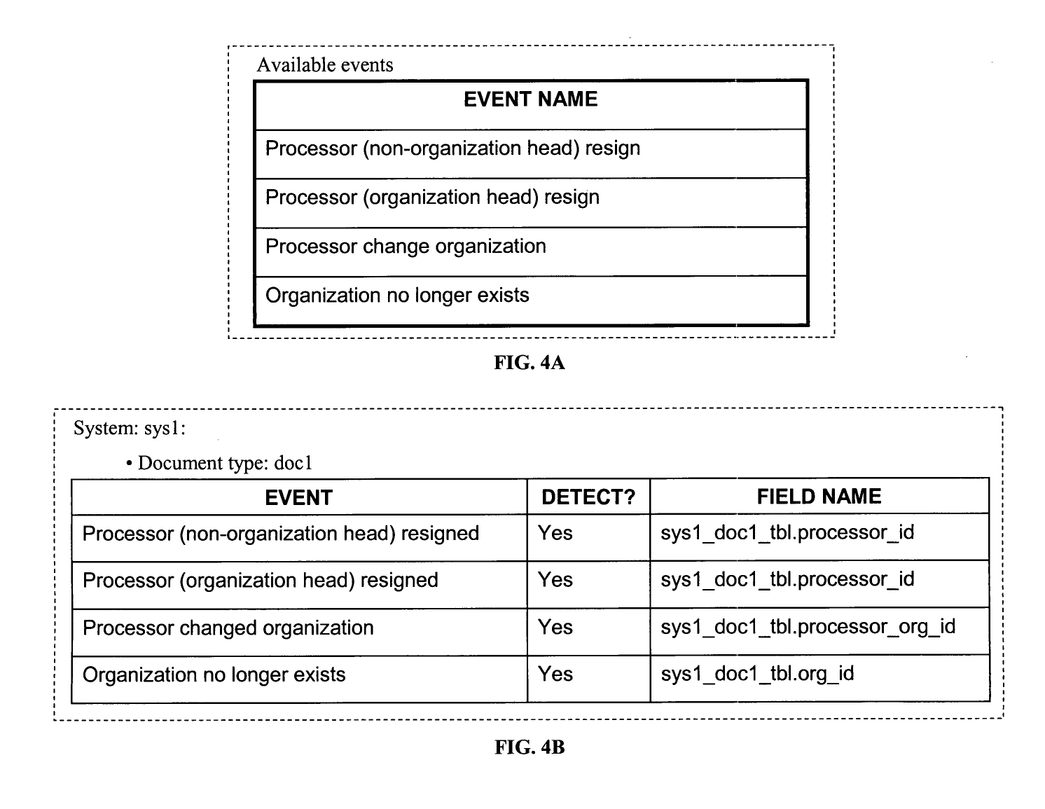

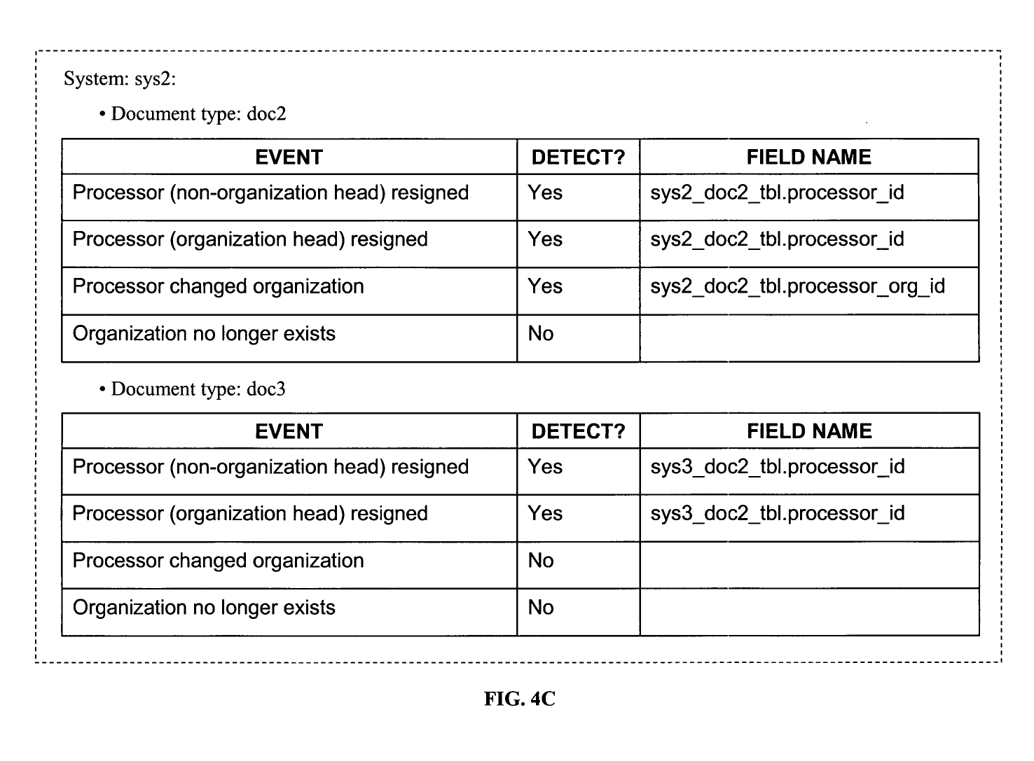

System agent 205 monitors documents with determined authority 250 to determine which of those documents are impacted by changes in the organizational hierarchy. FIG. 4A is a table of available personnel data change events that can impact the processing of a document. Such events include a) a processor (non-organization head) resigns, b) a processor (organization head) resigns, c) a change within the organization by a processor, for example when a processor moves from one department to another, and d) the organization no longer exists. When the term “non-organization head” is used, it includes managers, supervisors and other approvers in the organization under the organization head.

FIGS. 3A and 3B include process steps 301-305 which illustrate the flow of a workflow object or document through workflow system 200. As per step 301 in FIG. 3A, system agent 205 starts checking documents 205 to determine if any of the above personnel data change events have occurred that would be impact any of documents 205. If such an applicable event has occurred, it is a trigger event which triggers system agent 205 to send the impacted documents to re-authorization engine 210 of FIG. 3B. The documents 205 can be checked to see if they are impacted based on rules that are applicable on a system by system basis. For example, one set of rules can be applied to one system on which documents are stored and another set of rules can be applied to another system on which documents are stored. These rule sets are stored in rule configuration storage 255 of FIG. 3A on a system by system basis. In this particular example, system 1 rules and system 2 rules are stored in rule configuration storage 255 as shown and are provided to system agent 205 as per step 302.

FIG. 4B is a table which shows rules applicable to a System: sys1 with a document type: doc1. FIG. 4C is a table which shows rules applicable to documents in a System: sys2 and includes both a document type: doc2 and a document type doc3. The tables shown include event type, detect yes/no information, and a field name. The field name may identify a storage position of processor information within the document (e.g., if a document is stored in a relational database management system (RDBMS) as a row in a table, the field name may be one column name in this table). For example, when agent 205 is checking a document (system: sys1, document type: doc1), it may retrieve the original processor identification from the field/column: sys1_doc1_tbl.processor_id in the document and then check whether or not the processor is resigned. The agent 205 may then retrieve the processor's original organization identification from sys1_doc1_tbl.processor_org_id, and check whether it is still identical with the processor's current organization identification. The agent 205 may then retrieve the submitter's original organization from sys1_doc1_tbl.org_id, and check whether the organization still exists. It is understood that the rules described in the present disclosure are configurable and flexible, and that one single agent can use these configurations to take care of multiple information systems and multiple document types.

System agent 205 uses these rules to determine impacted documents on a system by system basis in one embodiment. Based on the rule configuration for each system, all documents are found where the specified field value matches the change events. If any personnel change event is found to have occurred that would impact a particular document 250, then system agent 205 is triggered for that document. Once triggered, the system agent can determine or detect all impacted documents in different systems according to the rule set of each system as per step 303 of FIG. 3A. After the system agent completes detection of the impacted documents, the impacted document collection is passed to reauthorization engine 210 as per step 304 in FIG. 3A.

In the particular example shown in FIG. 3A, 3 documents that were impacted by a hierarchy change have been identified and are collectively designated as “docs with improper authority”, namely document 001 (Sys1:Doc1) for which Processor A experienced an organizational change, document 002 (Sys2:Doc2) for which Processor B experienced an organizational change, and document 003 (Sys2:Doc3) for which Processor C (the organization head) resigned. As mentioned above, these 3 impacted documents are dispatched to and received by re-authorization engine 210 seen in FIG. 3B.

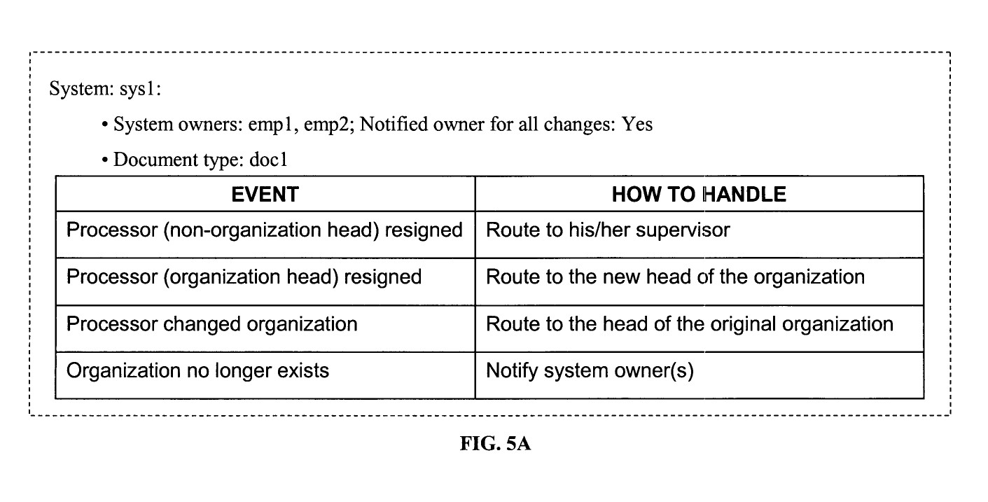

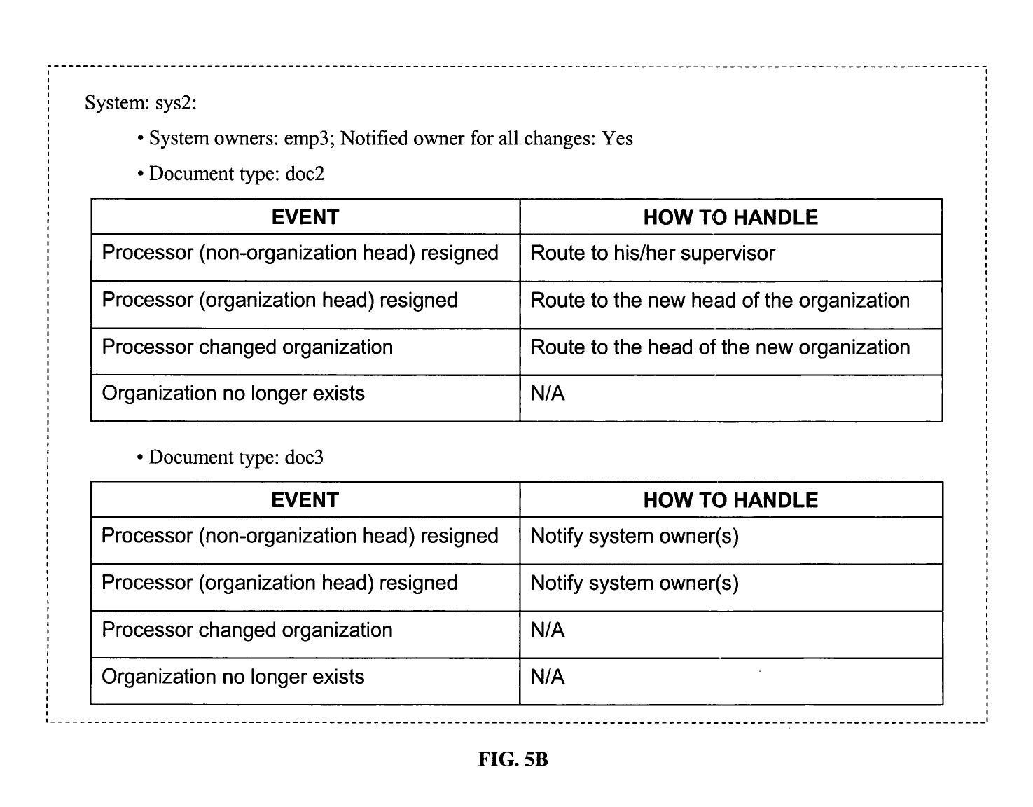

Re-authorization engine 210 retrieves re-authorization rules from rule configuration storage 260 that describe how each type of personnel change event is to be handled. FIG. 5A is a table showing a plurality of personnel change events and respective instructions regarding “how to handle” each event. For example, in the rules of FIG. 5A that apply to System: sys1, document type: doc, in this particular example, the event “Processor (non-organization head) resigned” is handled by “routing to his/her supervisor” and the event “Processor changed organization” is handled by “routing to the head of the original organization”. FIG. 5B shows rules that can apply to System: sys2 for document types: doc2 and doc3. As per step 305 of FIG. 3B the rules in rule configuration storage 260 are fetched by re-authorization engine 210 which applies the fetched rules to impacted document 001, Sys1:Doc1, impacted document 002 (Sys2:Doc2) and impacted document Sys2:Doc3. The fetched rules are then applied to each impacted document to determined the new routing path for that document. For example, as seen in FIG. 3B, document 001 is rerouted to the “head of the original organization”; document 002 is rerouted to “the head of the new organization”; and “no change” is made to the routing of document 003 other than “notifying the system owners”. With such rerouting finished as per step 306, the rerouted document becomes a document which has determined authority. The document is then transmitted to the appropriate processors and readers as determined by the application of the rules.

The present disclosure has been described relative to a preferred embodiment. Improvements or modifications that become apparent to persons of ordinary skill in the art only after reading this disclosure are deemed within the spirit and scope of the application. It is understood that several modifications, changes and substitutions are intended in the foregoing disclosure and in some instances some features of the disclosure will be employed without a corresponding use of other features. Accordingly, it is appropriate that the appended claims be construed broadly and in a manner consistent with the scope of the disclosure.

What is claimed is:

1. A method of controlling workflow comprising:
receiving workflow objects from original processors;
determining, by a system agent, if an organization change has occurred which impacts a particular received workflow object; and
re-authorizing, by a re-authorization engine, an impacted received workflow object to be processed according to a new routing path.

2. The method of claim 1 including storing impact rules in an impact rule storage.

3. The method of claim 2 including accessing impact rules by the system agent.

4. The method of claim 2 further comprising determining, by the system agent, an impacted workflow object in response to applying the impact rules.

5. The method of claim 1 including storing re-authorization rules in a re-authorization rule storage.

6. The method of claim 5 including accessing re-authorization rules by the system agent.

7. The method of claim 5 further comprising re-authorizing, by the re-authorization engine, impacted received workflow objects in response to the re-authorization rules.

8. The method of claim 1 wherein the workflow object is a document.

9. The method of claim 1 including forwarding a re-authorized impacted received workflow object to a new processor.

10. The method of claim 1 including forwarding a re-authorized impacted workflow object to a new reader.

11. A method of controlling workflow comprising:
receiving, by an authorization engine, workflow objects from original processors, the received workflow objects having respective routing paths associated therewith by the authorization engine;
determining, by a system agent, if an organization change has occurred which impacts a particular workflow object; and
re-authorizing, by a re-authorization engine, an impacted workflow object to be processed according to a new routing path.

12. The method of claim 11 including storing impact rules in an impact rule storage.

13. The method of claim 12 including accessing impact rules by the system agent.

14. The method of claim 12 further comprising determining, by the system agent, an impacted workflow object in response to applying the impact rules.

15. The method of claim 11 including storing re-authorization rules in a re-authorization rule storage.

16. The method of claim 15 including accessing re-authorization rules by the system agent.

17. The method of claim 15 further comprising re-authorizing, by the re-authorization engine, impacted received workflow objects in response to the re-authorization rules.

18. The method of claim 11 wherein the workflow object is a document.

19. The method of claim 11 including forwarding a re-authorized impacted received workflow object to a new processor.

20. The method of claim 11 including forwarding a re-authorized impacted workflow object to a new reader.

21. A workflow system comprising:
an input at which workflow objects are received;
a system agent, coupled to the input, that determines if an organization change has occurred which impacts a particular received workflow object; and
a re-authorization engine, coupled to the system agent, that re-authorizes an impacted received workflow object to be processed according to a new routing path.

22. The workflow system of claim 21 further comprising impact rule storage, coupled to the system agent, that stores impact rules.

23. The workflow system of claim 21 further comprising re-authorization rule storage, coupled to the re-authorization engine, that store re-authorization rules.

24. The workflow system of claim 21 wherein the system agent is a software application.

25. The workflow system of claim 21 wherein the re-authorization engine is a software application.

26. The workflow system of claim 21 wherein the workflow object is a document.

27. A workflow system comprising:
an authorization engine at which workgroup objects from original processors are associated with respective routing paths;
a system agent, coupled to the authorization engine, that determines if an organization change has occurred which impacts a particular received workflow object; and
a re-authorization engine, coupled to the system agent, that re-authorizes an impacted received workflow object to be processed according to a new routing path.

28. The workflow system of claim 27 further comprising impact rule storage, coupled to the system agent, that stores impact rules.

29. The workflow system of claim 27 further comprising re-authorization rule storage, coupled to the re-authorization engine, that store re-authorization rules.

30. The workflow system of claim 27 wherein the system agent is a software application.

31. The workflow system of claim 27 wherein the re-authorization engine is a software application.

32. The workflow system of claim 27 wherein the workflow object is a document.
